(19) United States
(12) Patent Application Publication
(10) Pub. No.: US 2025/0316148 A1
(43) Pub. Date: Oct. 9, 2025

(54) FREESTANDING KIOSK

(71) Applicant: SITA Information Networking Computing Canada Inc., Montreal (CA)

(72) Inventors: Daniel ALBINES, Montreal (CA); Anthony Vlade SABLJAK, Montreal (CA); Abhimunya PAUL, Montreal (CA); Ezana Tekie TESFAY, Montreal (CA)

(21) Appl. No.: 19/244,155

(22) Filed: Jun. 20, 2025

Related U.S. Application Data
(63) Continuation of application No. PCT/CA2023/051693, filed on Dec. 18, 2023.

(30) Foreign Application Priority Data
Dec. 21, 2022 (GB) 2219350.2

(51) Int. Cl. G07G 1/00; G06F 3/041; G07G 1/01

(52) U.S. Cl. CPC G07G 1/0018; G06F 3/0412; G07G 1/01

(57) ABSTRACT

There is provided a freestanding kiosk 100 having a front side and a rear side, the kiosk comprising: a body 110 for housing one or more internal components of the kiosk 100; a first display 111 on the front side of a top portion of the kiosk 100; a second display 112 on the rear side of a top portion of the kiosk 100; wherein the second display 112 is movable between a first position in which it is proximate the kiosk body 110 and a second position in which it is spaced away from kiosk body 110; and wherein the kiosk 100 is provided with at least two wheels 122 for transporting the kiosk 100.

### CROSS-REFERENCE TO RELATED APPLICATION

This application is a continuation of International Patent Application PCT/CA2023/051693, filed on Dec. 18, 2023, and entitled “FREESTANDING KIOSK,” which claims priority to United Kingdom Application No. 22191350.2, filed on Dec. 21, 2022, and entitled “FREESTANDING KIOSK,” the contents of which are incorporated by reference in their entirety as if set forth herein.

### FIELD OF THE INVENTION

The present invention relates in general to a freestanding kiosk for executing operations for users and to methods of manufacturing freestanding kiosks. More particularly, the present invention relates to such an interactive kiosk for use in large public or private spaces, such as airports, offices, shopping centres, event venues and rail or road stations. The present invention is particularly, but not exclusively concerned with such an interactive kiosk for use in an airport hub, rail or bus interchange, port or other travel interchange or termini.

### BACKGROUND OF THE INVENTION

The volume of passengers travelling through airports or other travel termini has increased significantly in recent years. This places a greater burden on managing authorities, and transport providers, to more effectively manage their resources to accommodate the ever increasing needs and size of their passengers groups. For example, increased passenger volumes can often result in increased congestion at airports. This increased congestion also slows down the throughput of passengers from the airport entrance to the aircraft. This congestion and increasing queues at check-in counters and prior to boarding an aircraft may result in departure delays for airlines and may also impact the airport with additional costs and inefficiencies, as more staff are required to manage and coordinate passengers and their baggage. Furthermore, increased congestion can become particularly problematic in uncontrollable or unexpected circumstances. For example, in the event of unexpected bad weather, or unexpected maintenance in a portion of the airport.

In recent years, a number of automated facilities and processes have been introduced in such transport termini, for the purposes of improving efficiencies. One example of such a facility is an automated interactive kiosk, with which passengers can interact with in order to perform identity checks or to obtain the likes of a boarding pass and/or a bag tag. When interacting with such kiosks for such purpose, passengers are typically required to carry out identity checks and/or to present the kiosk with an identity document, such as a passport, as part of an authentication process. In order to carry out such checks, kiosks typically have a camera for performing the identity check and/or an inbuilt scanner for scanning documents.

However, such kiosks may not always reliably identify the user or the document placed in the scanner. For example, some passengers may not know or not understand how to properly stand in front of the kiosk to carry out an identity check or properly scan a document, leading the operations failing. Another drawback of such kiosks is that they are not easily transportable in the event that the kiosks are required in another location.

In typical prior art arrangements, moving a kiosk from one place to another requires a lot of human effort. This may include: unplugging and dismounting the kiosk; lifting and moving the 100+kg kiosk; and rewiring for power and internet at the desired location. In addition, this takes a considerable amount of time. Not only is this inefficient, but the time taken would exceed the narrow timeframe in which a response to the extra capacity required is needed.

Accordingly, it would be desirable to provide a freestanding kiosk, which can overcome one or more of the above mentioned drawbacks with existing kiosks known in the art.

### SUMMARY OF INVENTION

As used herein, the terms “side”, “top”, “bottom”, “front”, “rear” and other terms used to describe relative positions of the components of apparatuses according to the invention, refer to the kiosk in an upright position with the first display at the top front. When describing kiosks according to the present invention, these terms are used irrespective of the orientation of the apparatus being described. The “bottom” of the apparatus refers to the side of the kiosk opposite the “top” of the kiosk.

The term “side”, used in relation to the front side or the rear side of the kiosk is synonymous with the term “surface” and refers to the surface of the kiosk facing at the front and rear of the kiosk respectively.

The term “height” is used herein to refer to dimensions extending between the top and the bottom. The term “width” is used herein to refer to dimensions extending between two sides. The term “depth” is used herein to refer to dimensions extending between the front and the rear. Height, width and depth are orthogonal to each other.

The invention is defined by the independent claims to which reference should now be made. Embodiments of the invention seek to address the above problems by providing an improved freestanding kiosk for enabling passengers to carry out identity checks or scan documents. Optional features are set forth in the dependent claims.

According to a first aspect, there is provided a freestanding kiosk. The kiosk has a front side and a rear side. The kiosk comprises: a body for housing one or more internal components of the kiosk; a first display on the front side of a top portion of the kiosk; a second display on the rear side of a top portion of the kiosk; wherein the second display is movable between a first position in which it is proximate the kiosk body and a second position in which it is spaced away from kiosk body. The kiosk is provided with at least two wheels for transporting the kiosk. In other words, embodiments of the present disclosure provide a freestanding kiosk which allows a passenger to more easily carry out identity checks or scan documents by enabling an operator to more easily help the passenger with such tasks. The present disclosure also provides a kiosk which can be easily transported within a transport hub in the event that the kiosk is required in another location.

In contrast to freestanding kiosks known in the art, the kiosk of the present invention comprises a second display on the rear side of the kiosk; wherein the second display is movable between a first position in which it is proximate the kiosk body and a second position in which it is spaced away from kiosk body. By providing such a second display, an operator is able to interact with the kiosk simultaneously with a passenger who is interacting with the kiosk at the first display. Advantageously, when an operator and a passenger interact with a kiosk according to the invention, the operator and the passenger are able to communicate, to resolve any issues which the passenger has encountered with identity checks or other operations being carried out on the kiosk. The second display being at the rear side of the kiosk also enables the operator interacting with the second display to be physically separated from the passenger interacting with the first screen. In particular, this allows distance between the operator and the passenger to be maintained when the two are interacting with the same kiosk. In more detail, the kiosk may act as a physical barrier between the operator and the passenger which may further reduce contact between the two. Furthermore, the provision of the second display may prevent the need for the need for the operator to interact with the same display as the passenger, thereby limiting contact between the operator and the passenger. The second display being movable between a first position in which it is proximate to the kiosk body and a second position in which it is spaced away from kiosk body, allows the second display to be conveniently, stowed away when input from an operator is not required. This may advantageously enable the kiosk to be made smaller to reduce the space needed for the kiosk when input from an operator is not required. The movable second display also enables the distance between a passenger and an operator interacting with the kiosk to be better maintained. More specifically when the second display is in the second position, the distance between the first display and the second display is increased compared with when the second display is in the first position. The second display may extend and/or duplicate the output of the first display. The second display may also improve the functionality of the kiosk by improving its ability to be transported from one location to another. In particular, the provision of a second display enables the kiosk to function in a location where there is limited equipment or infrastructure present. Embodiments of the invention may therefore have the advantage of providing a kiosk system for environments having limited infrastructure or resources. More specifically, the second display may enable an operator to resolve any issues encountered by a passenger using the kiosk without the need for any external equipment which may need to interact with the kiosk.

Furthermore, by providing the kiosk with at least two wheels, the kiosk can be easily transported to different locations within the transport hub depending on where it is needed. This is particularly useful for managing the flow of passengers through a transport hub. The ability to transport the kiosk also allows the kiosk to be easily removed and serviced without interfering with operations in the transport hub.

Optionally, when the second display is in the second position, the second display is at a distance of between 200 millimetres and 300 millimetres from the kiosk body. Advantageously, the second display being at a distance of between 200 millimetres and 300 millimetres from the kiosk body when it is in the second position enables the operator interacting with the second display to be physically separated from the passenger interacting with the first screen. This allows for a distance between the operator at the second display and the passenger at the first display to be maintained. The distance of between 200 millimetres and 300 millimetres from the kiosk body is adequate for enabling both the operator and the passenger to interact with the kiosk, without posing any risk of the weight of the second display causing the kiosk to fall over. Other embodiments of the kiosk are also envisaged in which the second display, when it is in the second position, is at a distance from the kiosk body of less than 200 millimetres or greater than 300 millimetres.

Optionally, the kiosk is an interactive kiosk. This advantageously allows a passenger and/or an operator to do more than merely gather information from the kiosk. In particular, this enables a passenger and/or operator to interact with the kiosk to perform operations.

The kiosk of the present invention may additionally comprise a control unit configured to modify the output of the first display based on user input to the second display. In particular, the control unit may extend or duplicate the output second display on the first display.

This advantageously allows an operator interacting with the second display to help a passenger at the first display remotely without having to touch or interact with the passenger's screen. This is particularly advantageous where the passenger encounters issues when performing operations on the kiosk.

Optionally, the second display is a touch display. This advantageously allows an operator to interact with the second display without the need for a substantial number or even any controls at the rear of the kiosk.

Optionally, the second display faces in a rearward direction of the kiosk. This allows an operator to interact with the second display of the kiosk whilst maintaining a distance with the passenger. It also enables the operator to interact with the second display of the kiosk without the passenger being able to see the second display.

Optionally, the second display is connected to an upper portion of the kiosk body by an articulated arm. The articulated arm advantageously allows an operator to modify the position or orientation of the second display to more easily view or interact with the second display. Alternatively, the second display may be connected to an upper portion of the kiosk by any other means which imparts the same functionality as an articulated arm such as, for example, a retractable frame.

Optionally, the articulated arm has at least two degrees of freedom. Optionally the articulated arm has at least three degrees of freedom. Optionally the articulated arm has four degrees of freedom. Optionally one of the degrees of freedom or the articulated arm allows the arm to be rotated 180 degrees about an axis proximate the rear wall of the kiosk. This advantageously allows an operator to operate the kiosk from a range of positions and angles depending on the space available. This may also advantageously allow the operator to rotate the second display towards the passenger such that the passenger can see both the first display and the second display. This is beneficial because the operator can more easily assist the passenger with operations being carried out on the kiosk.

The kiosk of the present invention may additionally comprise a base at a bottom portion of the kiosk body, and wherein the wheels of the kiosk are at the rear of the base. The base advantageously improves the stability of the kiosk and reduces the likelihood of the kiosk falling over if knocked or pushed. This is particularly useful when the second display is in the second position because the weight of the second display produces a moment of force which tends to push the kiosk towards tipping backwards, and the base counteracts this force. The size of the base may be increased depending on the stability required of the kiosk, i.e. which tip test standard it must comply with. The wheels at the rear of the base advantageously further improve the stability of the kiosk and prevent the kiosk from being inadvertently tipped over backwards. However, when the kiosk needs to be transported from one location to another, the kiosk can be tipped such that the wheels are the only point of contact between the kiosk and the floor and the kiosk wheeled freely.

Optionally, the base of the kiosk is substantially flat. The flat base of the kiosk advantageously allows a passenger or operator to stand close to the kiosk without the base interfering with them. The flat base also advantageously maximises the surface area of the base for a given amount of material used. Alternatively, the base may not be substantially flat along the entire surface of the base. In particular, the base may have a central portion which is not flat and a peripheral portion which is substantially flat.

Optionally, the kiosk further comprises a front facing camera. The front facing camera may allow the kiosk to perform identity checks by capturing an image or video of a face of a passenger which can be compared with an identity document or data stored in a database. Optionally, the front facing camera is a first front facing camera and the kiosk further comprises a second front facing camera. The second front facing camera may be located directly adjacent the first front facing camera. The second front facing camera may increase the field of view of the first camera.

Optionally the kiosk body extends at an angle relative to the ground, such that, in use, the top portion of the kiosk body is closer to a passenger than the bottom portion of the kiosk body. Preferably, the kiosk body extends at an angle of between 1 and 5 degrees relative to the ground. This allows a passenger to stand closer to the kiosk without the base of the kiosk or the bottom portion of the kiosk body interfering with the feet of the passenger. This also provides easier access to the first display and any other controls of the kiosk.

Optionally, the kiosk body defines a chassis assembly which structurally supports the kiosk body. The chassis assembly may be the heaviest element of the kiosk. Optionally, the kiosk body may further define an internal compartment and the kiosk further comprises a power supply unit disposed in the bottom portion of the internal compartment of the kiosk body. The power supply unit are typically heavy components, therefore, configuring the power supply unit to be in the bottom portion of the kiosk body helps to lower the centre of gravity of the kiosk to improve the stability of the kiosk. The base may also account for a relatively large proportion of the weight of the kiosk to further lower the centre of gravity. The first and second displays being at a top portion of the kiosk raises the centre of gravity of the kiosk, thus increasing the likelihood of the kiosk inadvertently falling over. Configuring the heavier components of the kiosk to be in a lower portion of the kiosk counteracts this. This is particularly useful when the second display is in the second position as the weight of the second display is off-centre. Optionally, the kiosk further comprises a chassis assembly. The chassis assembly may make up between 15 percent and 30 percent of the mass of the kiosk, preferably between 20 percent and 25 percent of the mass of the kiosk. The centre of gravity of the chassis assembly may be between 400 millimetres and 600 millimetres from the ground. Preferably, the centre of gravity of the chassis assembly may be between 500 and 550 millimetres from the ground. Optionally, the kiosk further comprises a head assembly in the top portion of the kiosk. The head assembly may comprise the first display. The head assembly may make up between 10 percent and 25 percent of the mass of the kiosk, preferably between 15 percent and 20 percent of the mass of the kiosk. The centre of gravity of the head assembly may be between 1200 millimetres and 1600 millimetres from the ground. Preferably, the centre of gravity of the head assembly may be between 1300 and 1500 millimetres from the ground. Optionally, the kiosk further comprises a stability plate assembly in the bottom portion of the kiosk. The stability plate assembly may comprise the base and the wheels. The stability plate assembly may make up between 10 percent and 25 percent of the mass of the kiosk, preferably between 15 percent and 20 percent of the mass of the kiosk. The centre of gravity of the stability plate assembly may be between 0 millimetres and 10 millimetres from the ground. Preferably, the centre of gravity of the stability plate assembly may be between 0 and 5 millimetres from the ground. Optionally, the kiosk further comprises a printer assembly and paper roll. The printer assembly may make up between 5 percent and 15 percent of the mass of the kiosk, preferably between 8 percent and 12 percent of the mass of the kiosk. The centre of gravity of the printer assembly may be between 800 millimetres and 1200 millimetres from the ground. Preferably, the printer assembly may be between 900 and 1100 millimetres from the ground. Optionally, the kiosk further comprises a bottom front panel in the bottom portion of the kiosk. The bottom front panel may make up between 5 percent and 10 percent of the mass of the kiosk. The centre of gravity of the bottom front panel may be between 300 millimetres and 600 millimetres from the ground. Preferably, the bottom front panel may be between 400 and 500 millimetres from the ground. Optionally, the kiosk further comprises an internal main component plate assembly. The internal main component plate assembly may be in the bottom portion of the kiosk. The internal main component plate assembly may make up between 5 percent and 10 percent of the mass of the kiosk. The centre of gravity of the internal main component plate assembly may be between 200 millimetres and 500 millimetres from the ground. Preferably, the internal main component plate assembly may be between 300 and 400 millimetres from the ground. Optionally, the kiosk further comprises a second display assembly. The second display assembly may comprise the second display and the articulated arm. The second display assembly may make up between 2 percent and 10 percent of the mass of the kiosk, preferably between 5 percent and 8 percent of the mass of the kiosk. The centre of gravity of the second display assembly may be between 1100 millimetres and 1600 millimetres from the ground. Preferably, the centre of gravity of the second display assembly may be between 1200 and 1400 millimetres from the ground. Optionally, the kiosk further comprises a door assembly. The door assembly may make up between 2 percent and 10 percent of the mass of the kiosk, preferably between 5 percent and 8 percent of the mass of the kiosk. The centre of gravity of the door assembly may be between 800 millimetres and 1000 millimetres from the ground. Preferably, the centre of gravity of the door assembly may be between 900 and 1100 millimetres from the ground. Optionally, the kiosk further comprises a top front panel. The top front panel may make up between 1 percent and 5 percent of the mass of the kiosk. The centre of gravity of the top front panel may be between 800 millimetres and 1200 millimetres from the ground. Preferably, the centre of gravity of the second display assembly may be between 1000 and 1100 millimetres from the ground. Optionally, the kiosk further comprises a ground box assembly. The ground box assembly may make up between 0 percent and 5 percent of the mass of the kiosk, preferably between 0 percent and 2 percent of the mass of the kiosk. The centre of gravity of the ground box assembly may be between 600 millimetres and 900 millimetres from the ground. Preferably, the centre of gravity of the ground box assembly may be between 700 and 800 millimetres from the ground.

Optionally, the centre of gravity of the kiosk is in the bottom half of the kiosk. This may advantageously improve the stability of the kiosk and reduce the likelihood of the kiosk falling over if pushed or knocked. Optionally, the centre of gravity of the kiosk is between 600 millimetres and 800 millimetres from the ground. Preferably, the centre of gravity of the kiosk is between 700 millimetres and 750 millimetres from the ground.

Optionally, the kiosk complies with the Static Stability Test (8.6.2.2) and/or the Relocation Stability Test (8.6.3) and/or the Glass Slide Test (8.6.4) and/or the Horizontal Force Test (8.6.5) of IEC 62368-1:2014 (2^{nd} edition). These tests involve various 10 degree tip tests and a 15 degree tip test in which the kiosk returns to its upright position when tipped in any direction or does not fall when on an inclined surface. Optionally, the kiosk complies with the 10 degree and the 15 degree tip test when the second display is in the second position. This advantageously ensures that the kiosk is adequately stable and can withstand being knocked or tipped without falling over.

Optionally, the control unit is configured to extract data from photographic or video imagery captured by the camera to verify the identity of a passenger. This can advantageously mean that the kiosk of the present invention is capable of identifying a passenger using the kiosk by comparing the data extracted from photographic or video imagery captured by the camera with an identity document or data stored in a database.

Optionally, the kiosk further comprises one or more dispensing means. The one or more dispensing means may comprise one or more of: a boarding pass printer, a bag tag printer, and a receipt printer. Different dispensing means may be of different sizes, allowing for different configurations of different dispensing means. For example, the internal compartment may be configured to house a plurality of bag tag printers or receipt printers, such as three of these printers, but a boarding pass printer may be larger. Therefore, in some embodiments, where the internal compartment houses a boarding pass printer, the internal compartment may only house one of a bag tag printer or receipt printer. In some embodiments, the maximum number of printers the internal compartment may house may be three printers. It will be understood that such an arrangement is exemplary, and any suitable configuration of dispensing means may be used as desired by a customer or passenger.

The kiosk of the present invention may additionally comprise one or more of: a document scanner; payment means; a card reader; a pin pad; a near filed communication (NFC) reader; a barcode reader; a lighting device such as a light emitting diode (LED); directional buttons; selection buttons; and an audio jack input. The kiosk body may comprise one or more of these interface devices. One or more of the interface devices may be configured to meet ADA requirements, for example an ADA compliant passport scanner. The card reader may be a payment card reader, or may be for authorization such as for a system login. The LEDs may comprise directional arrows configured to illuminate, directing a passenger to interact with a particular device on the device shelf such as a fingerprint scanner. Alternatively or in addition, the light may comprise an indicator light, configured to indicate that part of the module needs servicing or maintenance. The lighting device may also comprise a camera flash. The display may be an information display, for example to display instructions to a passenger interacting with the kiosk, or to display branding or advertisement information.

Optionally, the lighting device comprises one or more light sources. The one or more light sources may advantageously draw the attention of the passenger and also help to illuminate the face of the passenger to better carry out an identity check. The kiosk may comprise a first light source on one or both sides of the first display for drawing the attention of a passenger and also for illuminating the face of a passenger. The kiosk may comprise a second light source above the first display for drawing the attention of a passenger and for communicating the status of the kiosk. The kiosk may further comprise a third light source for drawing the attention of the passenger and indicating the location of the camera to assist a passenger in identifying the camera to help them to capture a good image or video for an identity check. The third light source may be in the form of chevrons. The one or more light sources may advantageously improve the images captured by the camera and increase the likelihood of an identity check being successful.

Optionally, the kiosk body has a substantially constant cross sectional shape along the height of the kiosk body. This has the advantage of providing suitable space for housing components in the kiosk body along the entire length of the kiosk. Configuring the kiosk body in such a way also improves the stability of the kiosk. In particular, this enables components of the kiosk to be stored in the bottom portion of the kiosk to lower the centre of gravity of the kiosk and improve stability.

Optionally the height of the kiosk body is at least six times greater than the width or depth of the kiosk body. Configuring the kiosk to have these dimensions means that the kiosk is relatively tall and thin with a small footprint. As such, a large number of kiosks can be located in a relatively small area. This can help to ease congestion in a transport hub by reducing queuing times and increasing the throughput of passengers through the hub. The small footprint of the kiosk allows the kiosk to be placed in tight spaces and makes the product more flexible in its use. Alternative embodiments of the kiosk are also envisaged in which the height of the kiosk body is less than six times greater than the width or depth of the kiosk body. Optionally, the height of the kiosk is between 1400 millimetres and 1700 millimetres. Preferably, the height of the kiosk is between 1500 millimetres and 1600 millimetres.

Optionally, the height of the kiosk is at least four times greater than the width and length of the base.

Optionally, the kiosk may be a lightweight kiosk. The kiosk may have a weight of less than 25 kilograms. This allows the kiosk to be more easily transported from one location to another in a transport hub. Optionally, the kiosk further comprises a handle at the rear of the kiosk for improving the mobility of the kiosk. Embodiments of the kiosk having wheels are particularly easy to transport as the kiosk can be wheeled from one location to another without the need for any additional equipment.

Optionally, the kiosk may be wirelessly connected to the internet. For example, the kiosk may be connected to the internet using WiFi®, third generation (3-G), fourth generation (4-G) or fifth generation (5-G) wireless protocols. This wireless connection to the internet may enhance the ability of the kiosk to be transported from one location to another because there is no need for a wired internet connection in the location where the kiosk is to be used.

According to a second aspect, there is provided a freestanding kiosk. The kiosk has a front side and a rear side. The kiosk comprises: a body for housing one or more internal components of the kiosk; a display on the front side of a top portion of the kiosk. The kiosk is provided with at least two wheels for transporting the kiosk.

According to a third aspect, there is provided a freestanding kiosk. The kiosk has a front side and a rear side. The kiosk comprises: a body for housing one or more internal components of the kiosk; a first display on the front side of a top portion of the kiosk; a second display on the rear side of a top portion of the kiosk; wherein the second display is movable between a first position in which it is proximate the kiosk body and a second position in which it is spaced away from kiosk body.

According to a fourth aspect, there is provided a method of manufacturing a freestanding kiosk. The method comprises the steps of: providing a body for housing one or more internal components of the kiosk; providing a first display on the front side of a top portion of the kiosk; providing a second display on the rear side of a top portion of the kiosk; wherein the second display is movable between a first position in which it is proximate the kiosk body and a second position in which it is spaced away from kiosk body; and providing at least two wheels for transporting the kiosk.

According to a fifth aspect, there is provided a method of manufacturing a freestanding kiosk. The comprises the steps of: providing a body for housing one or more internal components of the kiosk; providing a display on the front side of a top portion of the kiosk; and providing at least two wheels for transporting the kiosk.

According to a sixth aspect, there is provided a method of manufacturing a freestanding kiosk having a front side and a rear side. The method comprises the steps of: providing a body for housing one or more internal components of the kiosk; providing a first display on the front side of a top portion of the kiosk; providing a second display on the rear side of a top portion of the kiosk; providing a second display which movable between a first position in which it is proximate the kiosk body and a second position in which it is spaced away from kiosk body.

### BRIEF DESCRIPTION OF THE DRAWINGS

Embodiments of the invention will now be described, by way of example only, with reference to the accompanying drawings, in which:

FIG. 1 illustrates a perspective view of a freestanding kiosk according to an embodiment of the invention with a second display in a fully extended position;

FIG. 2 illustrates a side view of a freestanding kiosk according to an embodiment of the invention with a second display in a fully extended position;

FIG. 3 illustrates a front view of a freestanding kiosk according to an embodiment of the invention.

### DETAILED DESCRIPTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

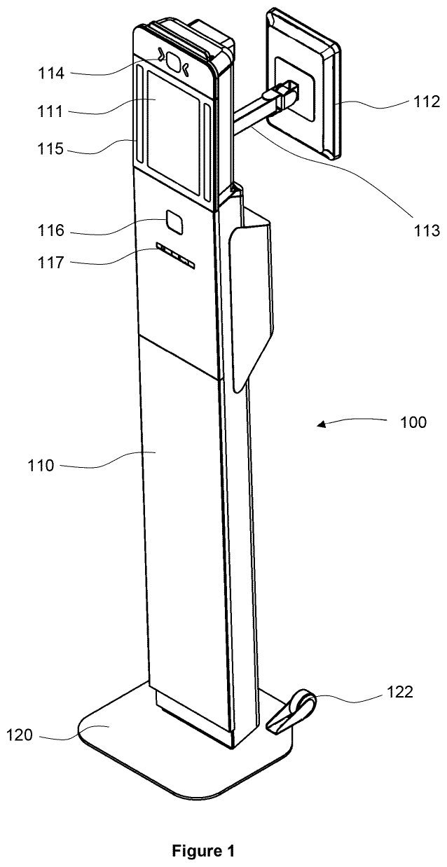

FIG. 1 illustrates a perspective view of a freestanding kiosk 100 according to an embodiment of the invention with a second display 112 in a fully extended position.

As shown in FIG. 1, the kiosk 100 has a body 110 for housing the internal components of the kiosk 100. The kiosk body 110 has a substantially constant cross section along the height of the kiosk. The kiosk 100 has a first display 111 on the front side of a top portion of the kiosk 100, and a second display 112 on the rear side of the top portion of the kiosk 100. The second display 112 is connected to the kiosk body 110 by an articulated arm 113 which allows the second display 112 to be moved between a first retracted position and a second extended position. The articulated arm 113 has a number of pivots and connections which give the articulated arm 113 a number of degrees of freedom. In FIG. 1, the second display 112 is in the second extended position in which it is spaced away from the kiosk body 110. In use, the display can be moved to the first retracted position in which it is proximate the kiosk body 110. The kiosk 100 further comprises a front facing camera 114. In use, the front facing camera 114 may be used to capture photographic or video imagery of a passenger using the kiosk 100. In this embodiment, the kiosk 100 further has elongate LED lights 115 on either side of the first display 111. These LED lights 115 may help to illuminate the face of a passenger or to indicate the status of an operation being performed by the kiosk 100. It will be appreciated that the LED lights 115 may take any suitable shape and may be located in other positions on the kiosk 100. The kiosk 100 of FIG. 1 further comprises a barcode scanner 116, which can be used to scan documents such as for example a boarding pass or a baggage tag. The kiosk 100 also includes a printer 117 for printing documents such as receipts, boarding passes, or baggage tags. It will be appreciated that kiosks according to the invention may comprise any number of printers or scanners and their placement on the kiosk is not to be limited by what is shown in the figures. A bottom portion of the kiosk 100 comprises a base 120. The base 120 is flat and has two wheels 122 at the rear of the base. When the kiosk 100 is to be transported from one location to another, it can be tipped backwards such that only the wheels 122 are in contact with the ground, and it can be freely wheeled around.

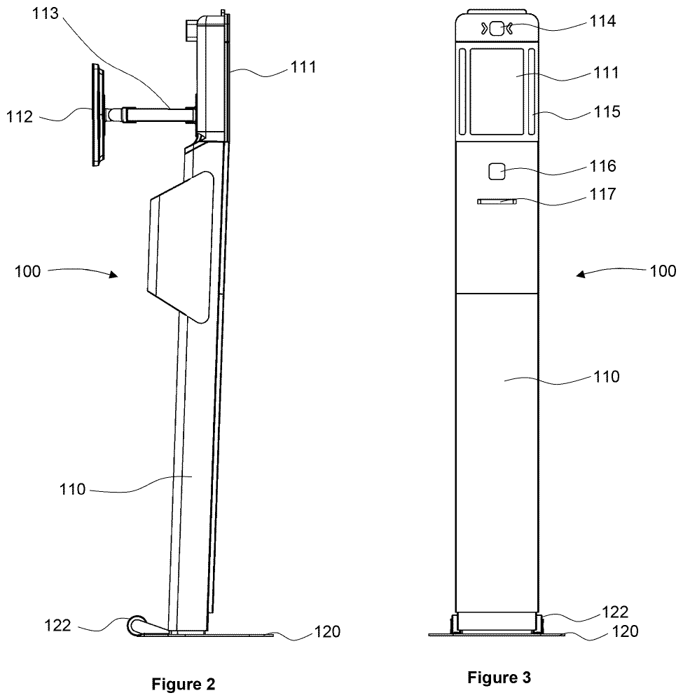

FIG. 2 illustrates a side view of a freestanding kiosk 100 according to an embodiment of the invention with a second display 112 in a fully extended position. For brevity, features of the kiosk 100 discussed above in respect of FIG. 1 will not be repeated. As shown in FIG. 2, the kiosk 100 extends at an angle relative to the ground, such that, in use, the top portion of the kiosk body 110 is closer to a passenger than the bottom portion of the kiosk body 110. It can also be seen that the top portion of the kiosk body 110, where the first display 111 and second display 112 are located is perpendicular to the ground. FIG. 2 more clearly shows the second display 112 and the articulated arm 113 in the fully extended position. FIG. 2 also shows that the base 120 extends further outwards at the front side of the kiosk 100, than at the rear side of the kiosk 100 to prevent the kiosk tipping over forwards towards a passenger.

FIG. 3 illustrates a front view of a freestanding kiosk 100 according to an embodiment of the invention. For brevity, features of the kiosk 100 discussed above in respect of FIGS. 1 and 2 will not be repeated. FIG. 3 shows that in this example embodiment, the components of the kiosk 100, i.e., the first display 111, the camera 114, the LED lights 115, the scanner 116 and the printer 117 are arranged symmetrically about a longitudinal axis of the kiosk 100. It will be appreciated that any suitable arrangement of the components is also encompassed by the invention. FIG. 3 also illustrates the arrangement of the two wheels 122 of this embodiment relative to the kiosk body 110.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A freestanding kiosk having a front side and a rear side, the kiosk comprising:
a body for housing one or more internal components of the kiosk;
a first display on the front side of a top portion of the kiosk;
a second display on the rear side of a top portion of the kiosk;
wherein the second display is movable between a first position in which it is proximate the kiosk body and a second position in which it is spaced away from kiosk body; and
wherein the kiosk is provided with at least two wheels for transporting the kiosk.

2. A freestanding kiosk according to claim 1, wherein when the second display is in the second position, the second display is at a distance of between 200 millimetres and 300 millimetres from the kiosk body.

3. A freestanding kiosk according to any preceding claim, wherein the kiosk is an interactive kiosk.

4. A freestanding kiosk according to claim 3, wherein the kiosk further comprises a control unit configured to modify the output of the first display based on user input to the second display.

5. A freestanding kiosk according to any preceding claim, wherein the second display is a touch display.

6. A freestanding kiosk, according to any preceding claim wherein the second display faces in a rearward direction of the kiosk.

7. A freestanding kiosk according to any preceding claim, wherein the kiosk further comprises a base at a bottom portion of the kiosk body, and wherein the wheels of the kiosk are at the rear of the base.

8. A freestanding kiosk according to claim 7, wherein the base of the kiosk is substantially flat.

9. A freestanding kiosk according to any preceding claim, wherein the kiosk body extends at an angle relative to the ground, such that, in use, the top portion of the kiosk body is closer to a passenger than the bottom portion of the kiosk body.

10. A freestanding kiosk according to any preceding claim, wherein the centre of gravity of the kiosk is in the bottom half of the kiosk.

11. A freestanding kiosk according to any preceding claim, wherein the second display is connected to an upper portion of the kiosk body by an articulated arm.

12. A freestanding kiosk according to claim 11, wherein the articulated arm has at least two degrees of freedom, preferably the articulated arm has at least three degrees of freedom, most preferably the articulated arm has four degrees of freedom.

13. A freestanding kiosk according to any one of claims 4 to 12, wherein the kiosk further comprises a front facing camera.

14. A freestanding kiosk according to any preceding claim, wherein the kiosk body defines an internal compartment and wherein the kiosk further comprises a power supply unit disposed in a bottom portion of the internal compartment of the kiosk body.

15. A freestanding kiosk according to any preceding claim, wherein the kiosk complies with Static Stability Test (8.6.2.2) and/or the Relocation Stability Test (8.6.3) and/or the Glass Slide Test (8.6.4) and/or the Horizontal Force Test (8.6.5) of IEC 62368-1:2014 (2^{nd} edition).

16. A freestanding kiosk according to claim 15, wherein the control unit is configured to extract data from photographic or video imagery captured by the camera to verify the identity of a passenger.

17. A freestanding kiosk according to any preceding claim, wherein the kiosk further comprises one or more dispensing means.

18. A freestanding kiosk according to claim 17, wherein the one or more dispensing means comprises one or more of: a boarding pass printer, a bag tag printer, and a receipt printer.

19. A freestanding kiosk according to any preceding claim, wherein the kiosk further comprises one or more of: a document scanner; payment means; a card reader; a pin pad; a near filed communication (NFC) reader; a barcode reader; a fingerprint scanner; a lighting device such as a light emitting diode (LED); directional buttons; selection buttons; and an audio jack input.

20. A freestanding kiosk according to claim 19, wherein the lighting device comprises one or more light sources for illuminating the face of a passenger.

21. A freestanding kiosk according to any preceding claim, wherein the kiosk body has a substantially constant cross sectional shape along the height of the kiosk body.

22. A freestanding kiosk according to any preceding claim, wherein the height of the kiosk body is at least six times greater than the width or depth of the kiosk body.

23. A freestanding kiosk according to any preceding claim, wherein the height of the kiosk is at least four times greater than the width and length of the base.

24. A freestanding kiosk having a front side and a rear side, the kiosk comprising:
a body for housing one or more internal components of the kiosk;
a display on the front side of a top portion of the kiosk;
wherein the kiosk is provided with at least two wheels for transporting the kiosk.

25. A freestanding kiosk having a front side and a rear side, the kiosk comprising:
a body for housing one or more internal components of the kiosk;
a first display on the front side of a top portion of the kiosk;
a second display on the rear side of a top portion of the kiosk;
wherein the second display is movable between a first position in which it is proximate the kiosk body and a second position in which it is spaced away from kiosk body.

26. A method of manufacturing a freestanding kiosk comprising the steps of:
providing a body for housing one or more internal components of the kiosk;
providing a first display on the front side of a top portion of the kiosk;
providing a second display on the rear side of a top portion of the kiosk;
wherein the second display is movable between a first position in which it is proximate the kiosk body and a second position in which it is spaced away from kiosk body; and
providing at least two wheels for transporting the kiosk.

27. A method of manufacturing a freestanding kiosk comprising the steps of:
providing a body for housing one or more internal components of the kiosk;
providing a display on the front side of a top portion of the kiosk; and
providing at least two wheels for transporting the kiosk.

28. A method of manufacturing a freestanding kiosk having a front side and a rear side comprising the steps of:
providing a body for housing one or more internal components of the kiosk;
providing a first display on the front side of a top portion of the kiosk;
providing a second display on the rear side of a top portion of the kiosk;
providing a second display which movable between a first position in which it is proximate the kiosk body and a second position in which it is spaced away from kiosk body.
